(19) United States
(12) Patent Application Publication
(10) Pub. No.: US 2018/0272647 A1
(43) Pub. Date: Sep. 27, 2018

(54) MODULAR REINFORCEMENT SYSTEMS AND METHOD

(71) Applicant: AKRON RUBBER DEVELOPMENT LABORATORY, INC., Akron, OH (US)

(72) Inventor: Michael Tobin Samples, Cuyahoga Falls, OH (US)

(73) Assignee: AKRON RUBBER DEVELOPMENT LABORATORY, INC., Akron, OH (US)

(21) Appl. No.: 15/927,137

(22) Filed: Mar. 21, 2018

Related U.S. Application Data
(60) Provisional application No. 62/474,269, filed on Mar. 21, 2017.

(51) Int. Cl. B32B 3/12

(52) U.S. Cl. CPC B32B 3/12; B32B 2305/08; B32B 2305/024

(57) ABSTRACT

The invention relates to modular reinforcement units for use in constructing a reinforcement structure, and associated systems and methods. The modular reinforcement units are designed to allow flexibility of design in the reinforcement structures that can be created for use in a wide variety of applications and products.

This application claims priority to, and the benefit of, U.S. Provisional Application No. 62/474,269 filed on Mar. 21, 2017 with the United States Patent Office, which is hereby incorporated by reference.

### BACKGROUND OF THE INVENTION

Examples described herein relate generally to structural systems and structures. More particularly, the invention is directed to modular assembly connecting members or units that are attachable to one another and formed into structures of simple or complex configurations. The invention also relates to systems and processes for construction of connecting units and structures formed therewith.

### DESCRIPTION OF THE RELATED ART

Products of many kinds have structural characteristics to perform various functions. To achieve the desired function, the ability to form complex shapes is needed leading to techniques such as molding, extrusion, and many other processes to form materials into desired configurations. Such processes are limited in the products that can be produced, and in their ability to form complex shapes. Three dimensional printing techniques have more recently been developed to allow production of products having desired shapes and structures, but again, such techniques are limited in terms of the size of products that can be produced or the structural characteristics that can be provided. It would be desirable to provide the ability to produce products having the desired shape, including complex shapes, while providing the ability to tune the physical and structural characteristics of a structure.

In another aspect, monolithic cellular and hollow-core structures formed from lightweight materials have been developed and are used for adding structural integrity to a structure. Monolithic cellular and hollow-core structures, however, are also limited in their ability to form complex shapes, or to provide desired structural characteristics. It would be desirable to be able to form a reinforced structure in any desired shape and configuration for use in a wide variety of applications, and it would be desirable to provide the ability to tune the physical characteristics of a structure, such as providing the ability to modify gauge/thickness, width, fill, weight, volume, and directional stiffness of such structures, for example.

### SUMMARY OF THE INVENTION

The invention addresses the need to provide the ability to form desired structures and products in a simple and effective manner. The invention utilizes modular assembly units that are combined to form a desired structure with flexibility in the formation of desired shapes and structural characteristics. Examples of a modular assembly unit comprise a body portion having a length, a width, and a depth. The body member includes at least one connector including a universal connector having a connector portion extending outwardly from a periphery of the body portion. The connector portion has a length, width and depth.

The body portion may also be formed to include at least one ligament. The modular assembly unit also includes at least one connector. The connector comprises a universal engagement member such as having a hook portion with a length, a width, and a depth. The hook portion extends outwardly from a periphery of the body portion. In some examples, the hook portion includes at least a portion extending back toward the body portion. Further, where a plurality of connectors are associated with the body portion, the portion extending back toward the body portion of each hook portion associated with each connector may be oriented in the same or different directions. The hook portion extending back toward the body portion may have at least a curved or rectangular portion extending back toward the body portion.

In various examples, the modular assembly unit includes a plurality of vertices. In some of these examples, at least one connector may extend from each vertex. In a particular example, the modular assembly unit includes at least three vertices. The body portion of the modular assembly unit may have a polygonal shape with a plurality of vertices spaced from one another. A plurality of ligaments can be used to connect the vertices to define edges of the body portion. In examples with a plurality of connecting portions, the connecting portions of each of the plurality of vertices may extend at angles relative to the other connecting portions.

Examples of the modular assembly unit include one or more voids formed between ligaments. The ligaments of the modular assembly or reinforcement unit may be perimeter ligaments forming a perimeter of the body portion in a direction of at least one of the length and the width of the body portion. In some examples, the one or more perimeter ligaments are formed as planar or are curved. The modular assembly unit may also include internal ligaments. The internal ligaments extend between perimeter ligaments or other internal ligaments. In various examples, the ligaments control at least the directional stiffness of the body portion. Alternately, the body portions may be solid or at least semi-solid to form a desired product or shape.

Examples of structures include a plurality of the modular assembly units as described above. In the structure, each modular assembly unit of the plurality of modular assembly units is securable to at least one adjacent modular assembly unit of the plurality of modular assembly units by a connector portion of each. Intersection of the connector portions prevent movement of each modular assembly unit in the direction of the length and width of the body portion. The engagement portion of each connector associated with each modular assembly unit may include at least a portion extending back toward the body portion. The portions extending back toward the body portion in the engagement portions of adjacent modular assembly units interconnect with one another. In some examples, the plurality of modular assembly units are identical to one another in the reinforcement structure. In yet other examples, at least some of the plurality of modular assembly units have different shapes in the structure. Additionally, the depth of at least some of the plurality of modular assembly units may vary. Examples of reinforcement structures may further comprise a layer of material positioned on at least one side of the plurality of modular assembly units.

A method of producing a structure is also provided. The method of producing a structure comprises defining the shape of and the one or more structural characteristics of a structure. The method also comprises defining a plurality of modular assembly units to form the defined structure. Further, the method comprises providing each of the plurality of modular assembly units with unique identification information as to the position of the unit in the defined structure. In an example, the method additionally comprises providing the modular assembly units in an un-assembled form and causing, or providing for, assembly of the structure at a site using the unique identification information.

The foregoing and other objects, features, and advantages of the examples will be apparent from the following more detailed descriptions of particular examples, as illustrated in the accompanying drawings wherein like reference numbers represent like parts of the examples.

### BRIEF DESCRIPTION OF THE DRAWINGS

Reference is made to the accompanying drawings in which particular examples and further benefits of the examples are illustrated as described in more detail in the description below, in which:

FIG. 1 is a view of a modular assembly member or unit, in accordance with an example.

FIG. 2 is a view of a structure, in accordance with an example.

FIG. 3 is a view of an alternative modular assembly member or unit, in accordance with an example.

FIG. 4 is a view of an alternative modular assembly member or unit, in accordance with an example.

FIG. 5 is a view of an alternative modular assembly member or unit, in accordance with an example.

FIG. 6 is a partial view of a structure formed of modular assembly units, in accordance with an example.

FIG. 7 is a partial view of a structure formed of modular assembly units, in accordance with another example.

FIG. 8 is a partial view of a structure formed of modular assembly units, in accordance with another example.

FIG. 9 is a partial view of a structure formed of modular assembly units, in accordance with another example.

FIG. 10 is a partial view of a structure formed of modular assembly units, in accordance with another example.

FIG. 11 is a partial view of a structure formed of modular assembly units, in accordance with another example.

FIG. 12 is a flow chart showing a process of constructing a structure.

### DETAILED DESCRIPTION OF THE INVENTION

Examples herein include modular assembly or reinforcement units formed from lightweight materials for use in creating structures, such as reinforcement or substrate type structures, with flexibility in shape, design and performance and structural characteristics. The modular assembly units of the invention provide the ability to customize the formation of a structure for a wide variety of applications. In one example, the modular assembly units can be used to form at least a part of a hollow-core structure, where the modular assembly units may form cells, that are then usable to form a structure, such as in a panel type configuration. Hollow core or other lightweight structures are used in a wide variety of applications where lightweight, but high strength structures, are needed and structural integrity are required. The structures that may be provided by construction of a plurality of modular assembly units may have outstanding out-of-plane compressive strength for handling stress/loading in any particular application, desired tensile, shear, bending and/or flexural strength tuned to a desired parameter, along with a high strength to weight ratio. The configuration of the modular assembly units allows for virtually unlimited configurations of structures to be constructed. In addition, the modular assembly units provide the ability to tune the physical characteristics of a structure formed therewith, such as providing the ability to modify or tune strength, fill, weight, volume, directional stiffness, shear, tensile, flexural and/or bending strength, or a variety of other characteristics in the structure, for example. The configuration of the modular assembly units provide connections with a universal engagement member or clasp which will accept any universal connector of an adjacent connecting unit. The connections between connecting units may be formed from an interengaging/interconnecting geometry formed of circular, semi-circular or planar portions in examples, which may be coupled to one another regardless of in-plane rotational orientation. The modular assembly units provide a customizable space between edges or corners, which may form the bulk of the unit structure, and can be optimized for weight, strength or through/in-plane physical functionality (thermal, electrical, flow, structural, etc.). The modular assembly units can form the corners of cells, or form sub-cells within themselves in the structure formed therewith. The connecting units may be formed as solid or semi-solid to provide desired structural characteristics. When individual units are attached to one another, the structure can be self-supporting, or can also serve as the reinforcing layer between solid, laminate or other boundary layers in a composite type product. Such products/structures could be used for example in automobile bodies, boat hulls, rotor blades, aerospace applications such as wings or other vehicle body structures, panels, lightweight doors, or a wide variety of other products. The modular assembly units can in essence be assembled in any three-dimensional profile, of limitless complexity, which may even include an arbitrary profile to match anything as random as the re-creation of a topographical map surface, spherical or polygonal shapes, air-filled shapes, etc. The modular assembly units used in a structure can be uniform and identical, or be manufactured to any contour such that individual units are positionally specific in a structure, such as in a 3D puzzle. The use of the modular assembly units of the invention to form a structure also allows for easy localized repair of the structure in the event of damage to one or more units. Further, the ability to customize the modular assembly units for a particular application allow for on demand manufacture of the units and shipping as individual units that are then assembled on-site for use, or even manufactured or printed on-site for assembly. The use of the modular assembly units of the invention to form a structure, also allows for easy localized repair of the structure in the event of damage to one or more units.

The modular assembly units may be made of any suitable material, including for example, steel, aluminum or other metals, composites, carbon fiber, polymeric materials, ceramic materials, epoxy resin, fibrous material(s), moldable material(s), thermoplastic or thermoset materials, other non-metallic materials, laminated materials and the like, or any such materials in combination.

Methods of manufacture for the various embodiments herein include, but are not limited to, additive manufacturing or 3D printing, extrusion, milling, molding, machining (including CNC machining, laser cutting, waterjet cutting, turning, or the like) manufacturing methods, etc., or any other suitable method or combination of methods. Software may additionally be used in combination with the methods of manufacture for designing and controlling the manufacturing process and identifying the method of assembly or installation. A combination of manufacturing methods may also be used. Stated another way, these manufacturing methods may include the various methods for forming a wide variety of products, with just a few examples being boat hulls, light-weight doors or wall panels, construction materials, building components, automotive or other vehicle products, aerospace products, or a multitude of other products. Embodiments of the present invention may be used to form the aforementioned products and/or serve as a reinforcing structure in a product, such as adjacent to or between one or more boundary layers.

Particular methods of manufacture may be better suited for different configurations of the one or more modules used to form the reinforcement structure. In one particular example, a reinforcement structure may be constructed comprising a constructed plurality of identical modular assembly units that may be cost effectively manufactured using extrusion techniques. Alternatively, the modular assembly units may be dissimilar and additive manufacturing techniques may allow flexibility to form a wide variety of modular assembly units designed to fit together in an efficient manner. Individual modular assembly units may have a varying thickness or other varying characteristic for an application.

In examples, the modular assembly units may each be formed, themselves, of varying or non-uniform profiles in one or more of the length, the width, and/or the depth. This may further expand the variations to the reinforcement structure. Moreover, uniform modular assembly units may be combined with non-uniform modular assembly units.

In examples, a modular assembly unit comprises a length, a width, and a depth. The modular assembly unit further comprises one or more connectors. The connectors secure the modular assembly unit to one or more adjacent connectors of an adjacent modular assembly unit to form a structure. The modular assembly unit may be solid or semi-solid, or may be formed of one or more ligaments extending from, between, and/or connecting to a plurality of connectors or to a single connector. The modular assembly units may include voids which are integrally formed within the modular assembly unit. The voids may be formed between the one or more connectors, the one or more ligaments, and/or within a connector of the one or more connectors and/or within a ligament of the one or more ligaments.

As indicated above, a plurality of modular assembly units, within a structure, may be secured to one another by one or more connectors. Examples of the connectors include, circular and/or semi-circular shapes that interconnect with similar shapes on the connector of another unit. Modular assembly units may also be connected using a combination of connectors. One particular embodiment of a connector is a universal engagement member, such as hook member or other interengaging member. A universal engagement member may be provided at each corner, edge, and/or at any position along the perimeter, top, and/or bottom of the modular assembly unit Likewise, the universal engagement member may be used in combination with other connectors. In this particular instance, the term ‘universal’ is used to identify an engagement member with a feature that engages and receives. In other words, the ‘universal’ feature of the engagement member is indistinguishable as an engaging feature or a receiving feature. This is in contrast to a fitting that conventionally comprises either a male engaging feature or a female receiving feature, each made to mate with the other and only the other. The universal engagement member increases flexibility for combining multiple modular assembly units into a reinforcement structure and eliminates the necessity to mate a male engaging feature with a female receiving feature. In some examples, a universal engagement member of a first modular assembly unit matches and may be a mirrored, or inverted, geometric shape of a universal class of a second or other modular assembly units. In other examples, the universal engagement members of adjacent units may be of a different dimension but still have a geometric shape to interconnect with an adjacent connector. In an example, the universal engagement member of a connector of a modular assembly unit may comprise a hook portion that seats within a similar hook portion of a universal engagement member of an adjacent modular assembly unit. In a particular example, the hook portion of a universal engagement member engages the hook portion of the adjacent universal engagement member securing the two hook portions together in at least a portion of the direction of the length and width. Further, the hook portions of the universal engagement members may be disengaged in a direction of the modular assembly unit depth.

The hook of a universal engagement member includes one or more transitions forming the hook configuration. In some embodiments, the hook comprises one or more geometric angles which may include inside angles and outside angles. Also, in some examples, the hook comprises one or more geometric curvatures which may include concave and convex curves. Other examples of the engaging portion of a universal engagement member may be a combination of geometric angles and geometric curvatures.

Each modular assembly unit comprises an internal area between and connecting the connector portions. This area may include one or more ligaments and one or more voids. Loads exerted on the connectors may transfer through so to also be supported by the ligaments or vice versa. Ligaments may be customized to support particular compression loads, tensile loads, or provide other structural characteristics or combinations thereof. One or more ligaments may extend from each connector and between multiple connectors forming perimeter ligaments about the perimeter of the modular assembly unit. Further, one or more ligaments may intersect one or more ligaments within each respective modular assembly units and/or the connectors, forming internal ligaments. An internal ligament may extend directly from a connector and intersect another ligament, extend between multiple internal ligaments, extend between perimeter ligaments, and/or a combination thereof.

The structural characteristics of the ligaments, and thereby the structural characteristics of the modular assembly unit, may be modified by the arrangement, orientation and geometry of the ligaments. The ligaments may include a curvature and/or a bend.

The arrangement of the one or more ligaments of a respective modular assembly unit create one or more voids. The arrangement of the one or more voids may be customized. Additionally, or alternatively, the one or more ligaments may include voids formed therein. Similarly, one or more ligaments of a first modular assembly unit may be separated from one or more ligaments of a second unit by a void. Depending on the structural characteristics of the structure formed by a plurality of units, the voids eliminate unnecessary weight within the structure. For example, the reinforcement structure formed by the modular assembly units may comprise a desired amount of void space while providing desired physical and structural characteristics.

The one or more ligaments include shear, tensile, compression, bending or other desired properties for the intended use. The mechanical properties of the one or more ligaments may be adjusted by quantity of ligaments, the geometric configuration of the ligaments, and/or the material used to form the ligaments within a modular assembly unit. These mechanical properties of each respective modular assembly unit and the assembled reinforcement structure may be further provided by the connectors. By example, the quantity of the connectors, the geometric configuration of the connectors, and/or the material used to form the connectors may be adjusted to achieve desired properties in the reinforcement structure. Moreover, the properties of the reinforcement structure may be further defined by the quantity of modular assembly units, the geometric configuration of the modular assembly units, and the materials used to form the modular assembly units within the reinforcement structure.

In one particular example, curvilinear ligaments may extend between connectors to provide desired bending properties or ability to absorb loads or control in-plane stiffness. Internal ligaments may be utilized to provide desired in-plane stiffness or other characteristics. Moreover, these various ligaments and connectors may be formed of one or more materials, further providing the ability to adjust the structural properties and, thereby, optimizing the modular assembly units for a particular application. Moreover, these various configurations may be adjusted in a manner which evenly or unevenly balances or distributes the strength, weight or other characteristic of a reinforcement structure, by adjusting such characteristics across a modular assembly unit and/or the entire structure based upon an intended use. The ability to tailor the structural characteristics of the modular assembly units allow tailoring the formed structure assembled therefrom as may be desired.

In some examples, the ligaments extend between adjacent ligaments and/or connectors in the direction of the length and/or width of each respective modular assembly unit. In other examples, some ligaments may also extend in the direction of the depth, thereby, connecting adjacent ligaments and/or connectors which are separated by the depth. These embodiments increase the flexibility of design and performance characteristics and provide additional adjustability of the structural properties.

A plurality of modular assembly units may be coupled to one another to form a reinforcement structure. Each modular assembly unit of a structure is connected to an adjacent modular assembly unit by one or more connectors. The reinforcement structure may take on a wide variety of configurations. The reinforcement structure may comprise modular assembly units of the same or different shapes, but that are designed to fit together in a predetermined manner to form the structure.

The ability to form a predetermined structure using a plurality of modular assembly units also provides unique attributes in terms of use. As the individual modular assembly units are coupled together to form the structure, they can be more efficiently and cost effectively handled, packaged and shipped than a preformed structure. Further, the individual modular assembly units can easily be transported to an end-user and/or a consumer for assembly on site. If the modular assembly units are similar to one another to form a planar structure for example, the user can assemble the desired structure with little instruction. If a three dimensional or other non-uniform structure is to be formed, each of the individual modular assembly units may be identified (i.e., numbered, labeled, organized, etc.) with information relating to the particular position within a structure. A suitable computer system and software may be utilized to provide the design and identification and may further provide instructions for constructing the structure on site. Alternatively, the individual modular assembly units may be designed for a particular structure and manufactured on site using additive manufacturing or other suitable techniques, for example, allowing a user to make and assemble the modular assembly units into a structure on site.

These and other examples of the modular assembly units and structures formed therewith as discussed above will now be described in further detail below in association with the accompanying Figures.

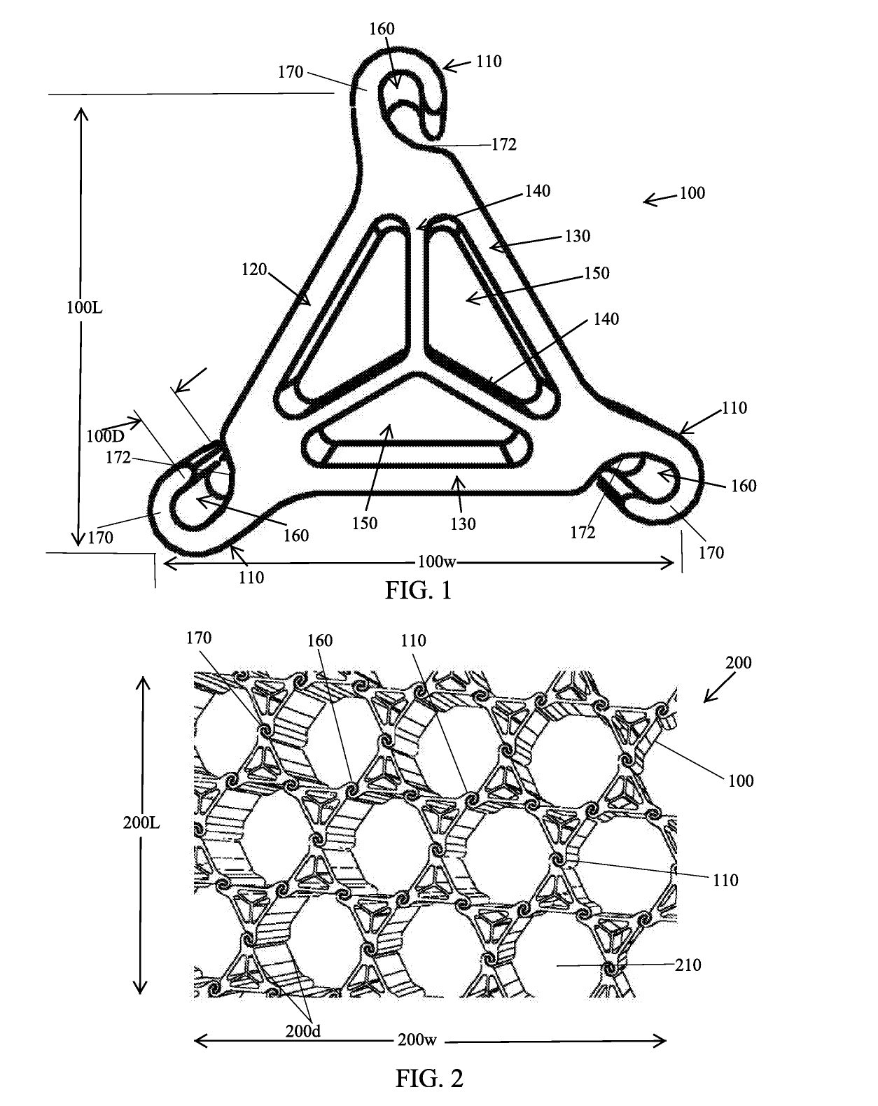

With reference to FIG. 1, an isometric view of an example modular assembly unit 100 for use in forming a structure is illustrated. The modular assembly unit 100 has a length 100_{L}, a width 100_{W}, and a depth 100_{D}. In this example, the modular assembly unit 100 includes a body portion in a generally triangular configuration, with a connector 110 formed at each vertex of the triangle. The modular assembly units may be any shape having any desired number of connectors, and may generally be formed in polygonal configurations with vertices, sides, and/or curves. Moreover, the module may be a combination of shapes. The connector may also be integral with the sides and/or curves of the modular assembly units, or may be made to be attached to the base unit, thereby allowing different connectors to be used with the base unit if desired. The base of the connector portion is formed and placed such that the base captures the apex of the adjacent piece's connector portion allowing for in-plane compressional, tensional and/or shear or other forces on the assembly to be accommodated or supported for a particular product as an example.

Still referring to FIG. 1, in an example, a body member is formed of one or more ligaments 120 extend between each connector 110 and also may extend in the interior portion of the modular assembly unit 100. The ligaments 120 between each connector 110 about the perimeter of the modular assembly unit 100 may be referred to as perimeter ligaments 130. The ligaments 120 within the modular assembly unit 100, extending between a connector 110 and another ligament 120, may be referred to as internal ligaments 140. The ligaments 130 and 140 together provide desired structural characteristics in the modular assembly unit 100. The use of internal ligaments 140 allows optimization or customization of the transfer of load between connectors 110 and in the resulting structure. The modular assembly unit 100 of FIG. 1 may be made of one or more materials, with configurations such as providing the connectors 110 formed of a different material than the interior portion of the modular assembly unit if desired.

The modular assembly unit 100 also may have voids 150. In this example, the voids 150 are formed between each ligament 120 and separate at least a portion of the ligaments 120. The voids 150 of FIG. 1 extend the depth 100_{D}. In other examples, the voids may only extend a partial depth, be exposed to one side or another of the modular assembly unit, and/or be an internal cavity within the unit. As an alternative, the modular assembly unit 100 may be formed without voids 150, to allow it to form a solid or semi-solid structure when combined with other modular assembly units.

In this example, the connectors 110 of the modular assembly unit 100 of FIG. 1 are a universal engagement member 160 which may include a connector portion 170. The universal engagement member 160 is for engaging a universal engagement member 160 of an adjacent modular assembly unit 100. In this example, the connector portion 170 is formed as a hook-type member in the direction of the length 100_{L} and the width 100_{W}. The universal engagement member 160 and its hook portion 170 have a depth 160_{D} extending the depth 100_{D}. In other examples, the universal engagement member 160 and connector portion 170 could extend in the direction of the depth 100_{D} if desired. In this example, the connector portion 170 includes a curved portion extending back toward the body portion. In this example, the curved portions extending back toward the body portion of each hook portion associated with each connector are oriented in the same direction. In this example, the base 172 of the hook shaped connector 170 is shaped and placed such that the base 172 captures the apex of an adjacent module's hook shaped connector 170 allowing for in-plane compression, tension, shear or other forces on the assembly to be accommodated or supported for a particular product. Also in this example, the body portion has a polygonal shape with a plurality of vertices spaced from one another, with a connector associated with each of the plurality of vertices and the hook portions of each extending at angles relative to the other hook portions 170. In this example, the plurality of perimeter ligaments 130 connect the vertices to define edges of the body portion. Other configurations for the connector portion 170 of engagement members 160 are contemplated beyond a hook type configuration, and could include interengaging members having curved or planar surfaces which are engageable with a mirror image connector on another unit 100. Turning to FIG. 2, a structure 200 is formed of a plurality of modular assembly units 100. The structure 200 has a structure length 200_{L}, structure width 200_{W}, and a structure depth 200_{D}. Each modular assembly unit 100 of the structure 200 is connected to an adjacent modular assembly unit 100 by a connector 110 formed on each modular assembly unit 100. The connectors 110 of FIG. 2 are universal engagement members 160 with a connector such as a hook portion 170, but other configurations may be used. In this particular embodiment, the hook portions 170 of each universal engagement member 160 are coupled to a hook portion 170 of an adjacent and adjoining modular assembly unit 100. The hook 170 of the modular assembly unit 100 engages and is secured with the hook 170 of the adjacent and adjoining modular assembly unit 100 such that the universal engagement member 160 is solidly connected or secured within the adjacent universal engagement member 160 in the direction of the length 100_{L} and the direction of the width 100_{W}. This provides for the structure 200 and the modular assembly unit 100 to resist both compressive and tensile (or other) forces in the direction of length 100_{L}, the structure length 200_{L}, the width 100_{W}, and the structure width 200_{W}. The hook portions 160 are easily coupled (or uncoupled) to one another by sliding the hook portions 170 of two universal engagement members 160 of adjacent connectors in the direction of the depth 100_{D}.

In the example of FIG. 2, the modular assembly units 100 are of uniform design, and allow formation of a structure 200 in at least a planar configuration. The planar configuration as shown may have any length 100_{L}, width 100_{W}, and depth 100_{D} as desired. As the individual modular assembly units 100 may also be made to allow some flexibility between connections to other modular assembly units 100, the structure 200 may be able to have curvature as may be desired.

Still referring to FIG. 2, structure voids 210 are formed within the structure 200. The structure voids 210 are formed between one or more modular assembly units 100 and/or separate one or more modular assembly units 100. The structure voids 210 are independent of the modular assembly unit voids 150 formed within each modular assembly unit 100. The ability to design the voids 150 and 210 into the structure 200 provides the ability to optimize weight vs. strength type parameters as may be desired for an application. Again, if desired, the modular assembly units 100 may be configured and coupled to one another to not provide voids 210 between them.

In FIGS. 1-2, the modular assembly units 100 are uniform, but it should be understood that the modular assembly units 100 may be non-uniform and the structure 200 may be of any simple or complex shape.

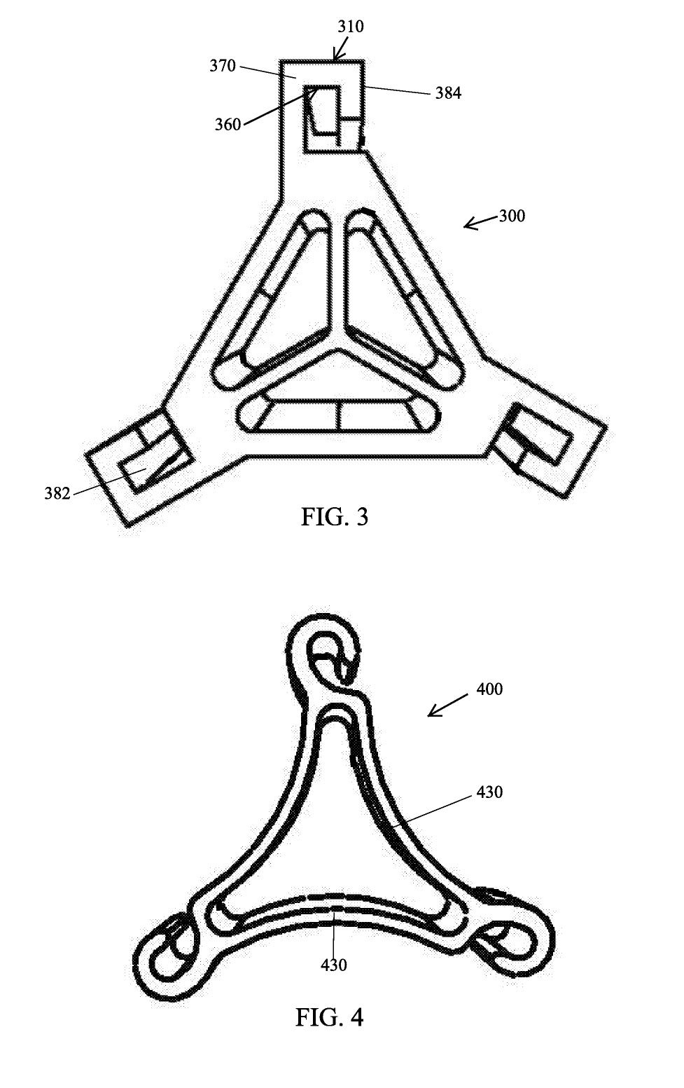

FIG. 3 illustrates an alternative example of a modular assembly unit 300 with a connector 310 having a universal engagement member 360 such as with a connector such as a hook portion 370. The hook 370 is formed in a squared off or rectangular configuration, with a planar surface extending back toward the body portion. The interconnection between these hook portions 370 in adjacent units 300 allows secure connection to one another. In contrast to the example of FIG. 1 which illustrates a curved hook 170, the flexibility of design of the hook portion allows for tailoring and customizing the stress concentrations, tensile and compression characteristics of the universal connectors. In this example, the curved portions extending back toward the body portion of each hook portion associated with each connector are oriented in the same direction.

FIG. 4 illustrates an alternative modular assembly unit 400 with perimeter ligaments 430 and no internal ligaments. The perimeter ligaments 430 of the modular assembly unit are curved. Using curved perimeter ligaments 430 and not using internal ligaments allows control of the in-plane stiffness of each unit 400 and therefore in the structure formed therewith. Further, designing the ligaments in a unit may also include design parameters wherein the space between corners of a unit, forming the bulk of the unit structure, can be optimized for weight, strength or through/in-plane physical functionality. This may include allowing systems to be incorporated into the structure formed by the units, such as thermal, electrical, fluid flow or other structural characteristics for example. In this example, the unit 400 without interior ligaments provides a through area in which wiring, plumbing, lighting, and/or heating/cooling systems may be positioned as may be desired for an application. The units can form the corners of cells, or form sub-cells within themselves in the assembly of the structure.

As previously noted, although examples of triangular type modular assembly units are shown herein, other numbers of universal connectors per modular assembly unit can be produced. In other examples, the modular assembly unit length, width or depth may be uniform or non-uniform as may be desired.

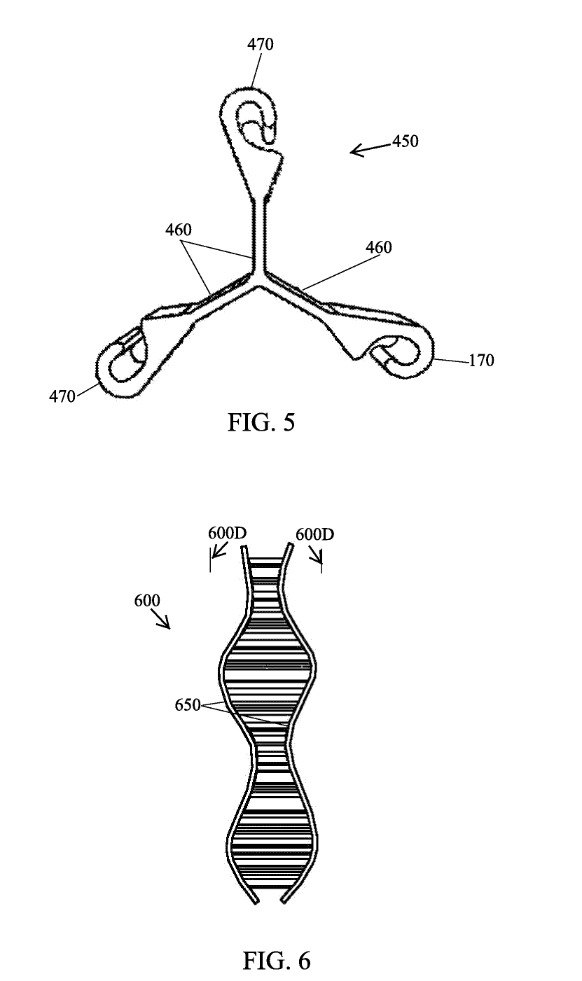

Another example of a module according to the invention is shown in FIG. 5. The module 450 includes three connectors 470 interconnected by ligaments 460, which forms a very lightweight and simple module for forming a structure.

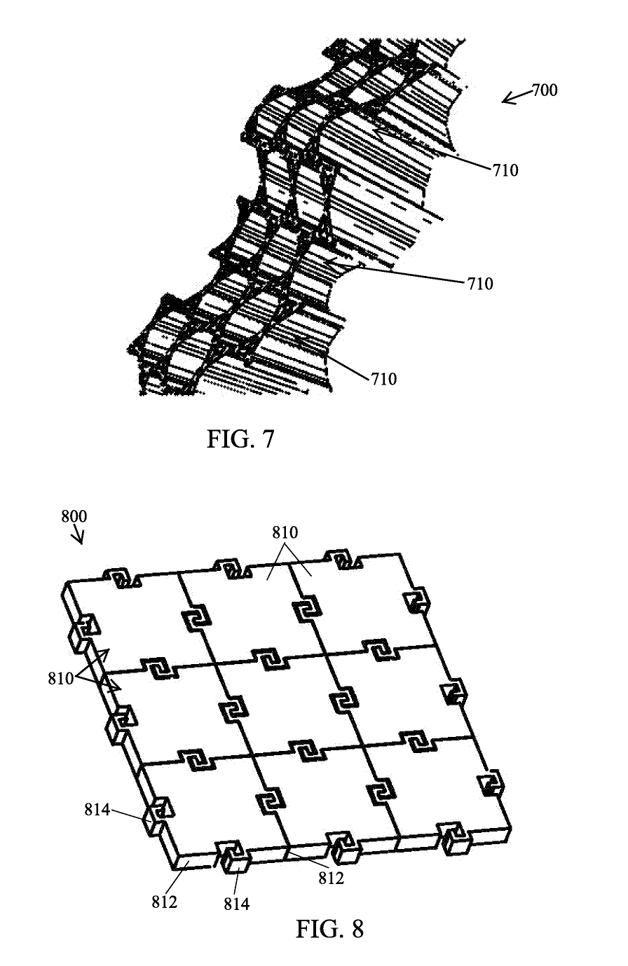

Turning to FIG. 6, a structure 600, such as a reinforcement or substrate structure, is illustrated in a side view taken of the structure profile or depth 600_{D} for a structure formed of modules according to the invention. The reinforcement structure 600 has a non-uniform depth to produce a curved profile as shown in FIG. 5. As an example, there also may be covering layers 650 on exterior surfaces of the structure 600 to form a panel type configuration. The covering layers 650 may be of any suitable construction, and may include one or more layers, and when applied to the structure 600, form a composite product. Such covers 650 may be of any suitable material(s), and be adhered onto the structure 600 or otherwise suitably attached. In this example, the structure 600 may be used in the construction of walls or other surfaces having a contoured configuration. A planar construction could simply be made instead to replace standard wall or other surface construction. Another example of a structure 700 is shown in FIG. 7, wherein modules 710 are connected to one another to form structure 700, with a non-planar configuration.

Turning to FIG. 8, another example of a structure 800 is formed by a plurality of modules 810. The modules 810 are formed with four vertices 812 in this example, with connectors 814 located in between vertices 812. The plurality of modules 810 may form a planar structure 800, or again, may form an irregular structure where modules 810 are dissimilar across at least a portion of the structure 800. Also in this example, the modules 810 do not have any void space to form an effectively solid surface when connected to adjacent modules 810 in the structure 800.

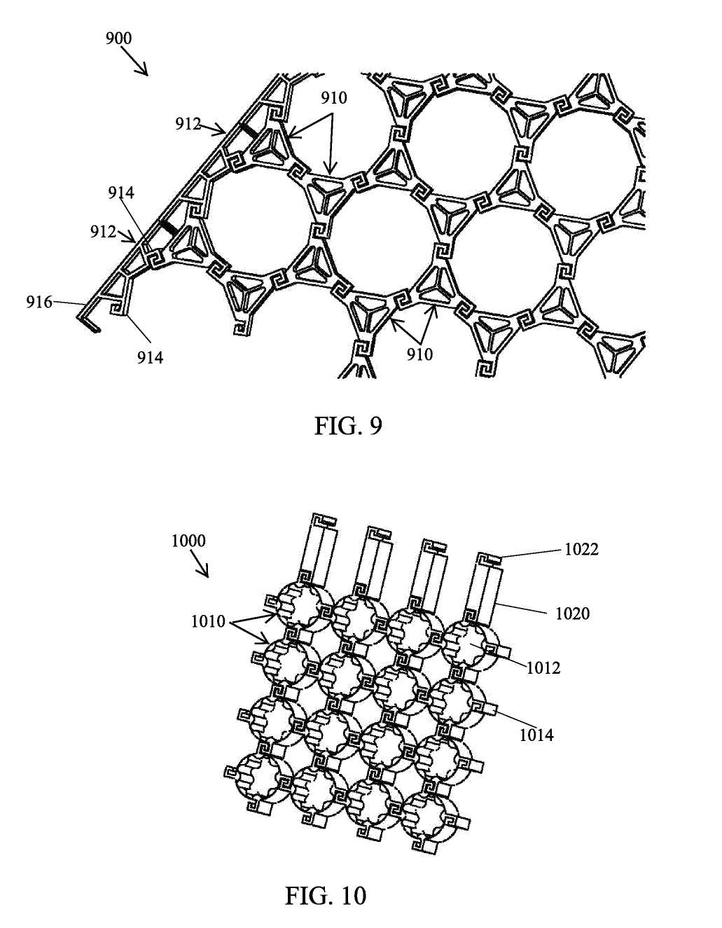

Turning to FIG. 9, another example of a structure 900 is shown to be formed by a plurality of modules 910 and 912. In this example, the modules 910 may be similar to those described in the example of FIG. 3, to form an interior of the structure 900 when connected to other modules 910. At the edges of the structure 900, the modules 912 form a finished edge to the structure 900. As seen in this example, the modules 912 may include two connectors 914 that connect to a connector on the modules 910. The modules 912 may also include extending sections 916 that interface with an extension 916 on an adjacent module 912 to form the finished edge to the structure 900. In conjunction with other modules, the structure formed may be a substantially finished product for use in a predetermined manner, or may be comprised of finished portions and other portions that may serve as reinforcement or for some other function.

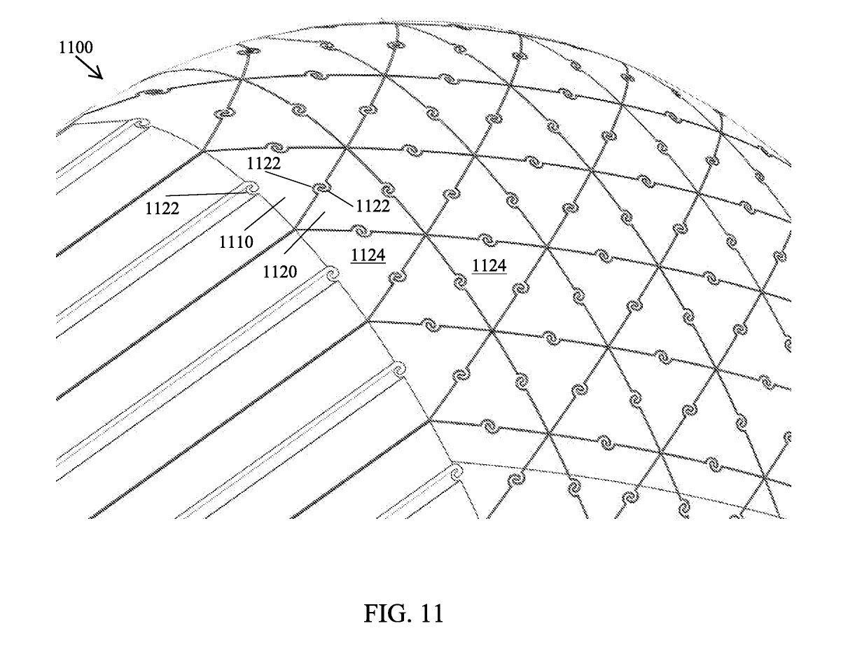

FIG. 10 shows another example of a structure 1000 formed of modules 1010 and 1020. In this example, the modules 1010 are formed in a circular type of shape with an interior void 1012 and four connectors 1014. Another type of module 1020 may be attached to a connector associated with modules 1010. The modules 1020 may include two connectors 1022. The modules 1020 are generally formed as a ‘line’ module which may be used to bridge to an adjacent structure. The modules 1020 may be structured to handle an in-plane load along the line of the module 1020. Alternatively, the modules 1020 may be formed with only a single connector 1022 to allow it to form an outside edge of the structure 1000 and give the edges the desired finished or flat attachment surface instead of having universal engagement members 1022 that are not connected to an adjacent connector. Such an attachment surface may be normal to the plane of exterior surface of a structure for example.

FIG. 11 shows another example of a structure 1100 formed of modules 1110 and 1120. In this example, the modules do not include ligaments and/or connectors, but are solid or semi-solid, and produce a solid or at least semi-solid product or structure when a first module 1110 is coupled to a second module 1120 via the universal connectors 1122. As illustrated, each module may, independently, be referred to as solid, monolithic, without voids, or the like. As illustrated by this example, a structure 1100 formed entirely of solid modules 1110 and 1120 is, additionally, solid. To form a complex shape, the individual modules 1110 and 1120 may have formed ends 1124 that enable the structure 1100 to be of any desired outer shape. In this example, the formed ends 1124 of each individual modules 1110 and 1120 to be shaped to result in a spherical or curved surface as shown. Any arbitrary shape (like the spheroid shown) can be created using these modules, with properly formed ends. The desired formed ends 1124 may be formed from cutting, molding or the like, or integrally while manufacturing the modules 1110 and 1120 for example. In these examples, the adjacent contacting walls of each individual module 1110 and 1120 support the assembled super-structure, and provide strength or other desired characteristics in the structure 1100. It also is contemplated herein that solid modules 1110 and 1120 may additionally be combined with the modules as taught by any prior example. Additionally or alternatively, solid modules may be provided to form a structure wherein the structure comprises one or more internal voids. By example, the structural void may be provided in an area of the structure lacking of modules and/or between modules. Such a structural void may be formed within the structure and/or may be formed at a surface of the structure. A structural void formed within the structure may be further concealed when the structure is complete with the requisite or desired modules, as designed for manufacture. Structural voids as defined here may additionally be formed within the structures formed of modules as taught by prior examples or a combination of examples.

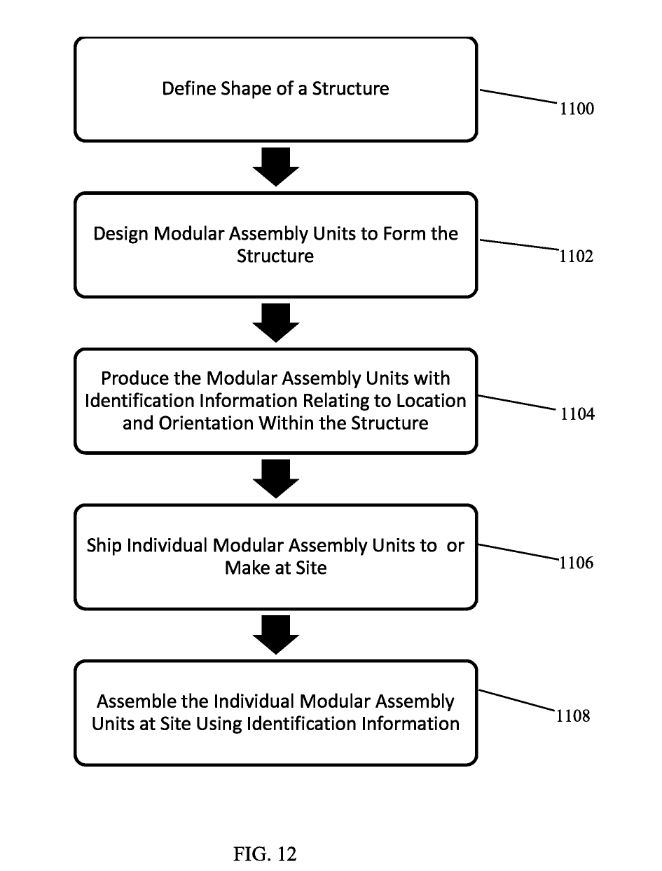

Turning to FIG. 12, a process of constructing a structure. The invention provides the ability to define the shape of and structural characteristics of a structure at 1100. The modular assembly units needed to form the design of the structure may then be designed at 1102. Each modular assembly unit may be provided with unique identification information as to the position of the unit in the structure at 1104. The modular assembly units may then be shipped to an end user in an unassembled form at 1106. The end user may then assemble the structure on site at 1108. As an alternative, the design of each of the modular assembly units with identification information may be provided to the end user who then fabricates (such as by additive manufacturing techniques) and assembles the modular assembly units on site.

The terms “comprising,” “including,” and “having,” as used in the claims and specification herein, shall be considered as indicating an open group that may include other elements not specified. The terms “a,” “an,” and the singular form of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things are intended. The terms “preferably,” “preferred,” “prefer,” “optionally,” “may,” and similar terms are used to indicate that an item, condition or step being referred to is an optional (i.e., not required) feature of the embodiments.

While this invention has been described with reference to embodiments thereof, it shall be understood that such description is by way of illustration only and should not be construed as limiting the scope of the claimed embodiments. Accordingly, the scope and content of the embodiments are to be defined only by the terms of the following claims. Furthermore, it is understood that the features of any embodiment discussed herein may be combined with one or more features of any one or more embodiments otherwise discussed or contemplated herein unless otherwise stated.

What is claimed is:

1. A modular assembly unit comprising:
a body portion having a length, width and depth;
at least one connector including a universal engagement member having a connecting portion extending outwardly from a periphery of the body portion, the connecting portion having a length, width and depth.

2. The modular assembly unit of claim 1, where the connecting portion includes at least a portion extending back toward the body portion.

3. The modular assembly unit of claim 2, where a plurality of connecting portions are associated with the body portion and the portion extending back toward the body portion of each connecting portion associated with each connector are oriented in the same direction.

4. The modular assembly unit of claim 1, where the connecting portion includes at least a curved or rectangular portion extending back toward the body portion.

5. The modular assembly unit of claim 1, where the body portion has a plurality of vertices and a connector extends from at least one vertex.

6. The modular assembly unit of claim 5, where the body portion includes a finished edge.

7. The modular assembly unit of claim 1, where the body portion has a polygonal shape with a plurality of vertices spaced from one another, and a plurality of ligaments connect the vertices to define edges of the body portion, with a connector associated with each of the plurality of vertices and the hook portions of each extending at angles relative to the other hook portions.

8. The modular assembly unit of claim 1, where a plurality of ligaments form at least a part of the body portion.

9. The modular assembly unit of claim 8, where the one or more voids are formed between ligaments.

10. The modular assembly unit of claim 8, where the ligaments include at least one perimeter ligament forming at least a part of the perimeter of the body portion.

11. The modular assembly unit of claim 10, where the ligaments further include internal ligaments extending between perimeter ligaments or other internal ligaments.

12. The modular assembly unit of claim 8, where the ligaments control the directional stiffness of the body portion.

13. The modular assembly unit of claim 1, where the body portion is formed as a solid member.

14. The modular assembly unit of claim 14, where the end portions of the body portion are formed to have a predetermined shape corresponding to an assembly formed by a plurality of modular assembly units.

15. A structure comprising:
a plurality of modular assembly units, the modular assembly units comprising a body portion having a length, width and depth, and at least one connector including a universal engagement member having a connecting portion extending outwardly from a periphery of the body portion, the connecting portion having a length, width and depth, where each modular assembly unit of the plurality of modular assembly units is securable to at least one adjacent modular assembly unit of the plurality of modular reinforcement units by a connecting portion of each, wherein intersection of the connecting portions prevent movement of each modular assembly unit in the direction of the length and width of the body portion.

16. The structure of claim 15, where the plurality of modular assembly units are identical to one another.

17. The structure of claim 15, where at least some of the plurality of modular assembly units have different shapes.

18. The reinforcement structure of claim 15, where the depth of at least some of the plurality of modular reinforcement units varies.

19. The reinforcement structure of claim 15, further comprising at least one layer of material positioned on at least one side of the plurality of modular assembly units.

20. A method of producing a reinforcement structure comprising:
defining the shape of and structural characteristics of a structure;
defining a plurality of modular assembly units to form the defined structure;
providing each of the plurality of modular assembly units with unique identification information as to the position of the assembly unit in the defined structure.
